(19) United States
(12) Patent Application Publication
(10) Pub. No.: US 2009/0283601 A1
(43) Pub. Date: Nov. 19, 2009

(54) SENSOR FOR MARKS ON OR IN MATERIAL AND METHOD OF SENSING A MARK ON OR IN A MATERIAL

(75) Inventors: Stephan SCHULTZE, Lohr (DE); Holger SCHNABEL, Rottendorf (DE)

Correspondence Address: HODGSON RUSS LLP;THE GUARANTY BUILDING, 140 PEARL STREET, SUITE 100, BUFFALO, NY, 14202-4040, US

(73) Assignee: ROBERT BOSCH GMBH, Stuttgart (DE)

(21) Appl. No.: 12/465,940

(22) Filed: May 14, 2009

(30) Foreign Application Priority Data
May 17, 2008 (DE) 10 2008 024 104.0

(51) Int. Cl. G06K 7/10; G06K 9/00

(52) U.S. Cl. 235/470; 382/103

(57) ABSTRACT

A sensor (100) for sensing a mark (502) on or in a material comprises a camera sensor (102) that is designed to scan a portion (106) of the surface of the material (402) for the mark (502) at least by a line scan. The sensor (100) also comprises an analyzing logic unit (104) that is coupled to the camera sensor (102) and designed to emit, when a mark (502) on that portion (106) of the surface of the material (402) that is scanned is detected by the camera sensor (102), a signal (108) for the detection of a mark on or in the material, which signal (108) corresponds to a position of the mark (502) on or in the material (402), the analyzing logic circuit (104) also being designed to use logic elements set to perform fixed logic operations to determine the signal (108) for the detection of a mark.

### CROSS REFERENCE TO RELATED APPLICATIONS

This application claims priority of German patent application no. 10 2008 024 104.0 filed May 17, 2008, which is incorporated by reference herein.

### FIELD OF THE INVENTION

The present invention relates to a sensor for marks on or in material. The invention also relates to a method of sensing a mark on or in a material. The invention relates in addition to the two-dimensional sensing of a mark on or in a material.

### BACKGROUND OF THE INVENTION

When a web of material is being processed, a register control system may be used in a machine (e.g. a printing press or processing machine) processing the said web of material in order to keep the web of material in a guide.

FIG. 4 shows the structure of a web processing machine 400 of this kind that has appropriate register control means 401. Basically, a web processing machine 400 operates as follows:
A web of material 402 is fed into the machine 400.
The web of material 402 is guided in the machine 400 by web transporting rollers 403 (belonging for example to an infeed unit or an outfeed unit).
The web of material 402 is processed in the machine 400 by cylinders for doing processing work.
The cylinders for doing processing work are usually checked by register control means 401.
As an option, the web transporting rollers may also be checked at the same time (e.g. in what is referred to as insetting).

It is also possible for a plurality of rollers to be involved in the transporting of the web in this case.

It is true of web processing machines 400 in general that:
The web of material may be of paper, fabric, card, film (plastics material), foil (metal), rubber, etc.
The types to which web processing machines belong may, in particular, be rotary printing presses (for newspaper printing, packaging printing, etc.), processing machines (envelope-making machines, sheet cutters, perforators), packaging machines, etc.

In these machines, printed marks have, to date, been applied to the web 402 in a preceding stage of processing so that a subsequent processing operation can be synchronized with the results of the processing performed in the preceding stage. Printed marks or marks in or on the material that can then be used by the web processing machine 400 may also be applied to the web of material 402 even before the processing of the said web begins. Printed marks of this kind or marks in or on the material of this kind have to be scanned by means of sensors. What are used for this scanning are, for example:
binary sensors for printed marks (e.g. the Sick KT10-2),
binary camera-based sensors,
camera systems (e.g. the Sick IVC-2D),
sensors for streams of printed marks.

By means of these sensors, the point in time at which the printed mark is below the sensor is determined and is fed to an automation system with great accuracy by means of
binary signals (e.g. in the case of sensors for printed marks) and/or
by the transmission of data on the positions measured (e.g. in the case of a camera system).
   Using this information, the automation system is able to determine the position both in the direction in which the web is transported (the longitudinal direction) and in the transverse direction and is able to initiate correcting measures if required. The control thereby performed is also referred to as control of longitudinal register (control in the direction in which the web is transported) and control of lateral register (control in the direction transverse to the direction in which the web is transported).

### Binary Sensors for Printed Marks

Where use is made of sensors for printed marks that produce binary outputs, what may be scanned are for example so-called triangle marks 502 of which a single example is shown in FIG. 5. The triangle mark 502 may for example measure, in this case, 6 mm in length in the direction 504 in which the web travels and 10 mm in width in a direction at right angles to the direction 503 in which the web travels. A spot of light 506 is projected onto the web of material 402 by means of a contrast sensor, and the light that is reflected from the web 402, or rather from the punched hole or colored mark forming the mark 502, is analyzed by a sensing device that is not shown in FIG. 5. If the web of material 402 is moving in the direction of transportation 504, conclusions can be drawn as to the position of the web of material 402 in the web processing machine 400 from the analysis that is made of how the web of material 402 reflects or from the length in time of a signal for reflection emitted by the sensor. The spot of light 506 is considerably smaller in this case than the triangle mark 502.

The binary signal from the sensor is typically a 24 V signal and represents the contrast characteristics of the mark 502, i.e. when for example the spot of light meets the mark, the signal leaps from 0 V to 24 V.

With an arrangement of this kind, it becomes possible for a measurement to be made of longitudinal register if for example what is measured is the edge of the mark 502 that is orthogonal to the direction of travel 504 of the web. A measurement of lateral register becomes possible with an arrangement of this kind if what is measured is the length in time of the signal from the sensor. This length in time is a measure of the position of the mark 502 relative to the spot of light 506 in the direction at right angles to the direction of travel 504 of the web.

The electrical binary signal is then read into the automation system and converted into a position (e.g. by means of a so-called measuring sensor function).

Disadvantages that exist when use is made of binary sensors for printed marks are that
Only a few types of mark can be detected because the sensor detects a printed mark by using a spot of light rather than by using image-processing techniques.
A different setting for the sensor or even a different sensor has to be selected to suit the color of the printed mark. The spot of light produced by a light source in the sensor is generally monochrome and is therefore not able to detect every color. Where required by the color of the mark to be detected, the sensor may have to be replaced or an additional sensor may have to be present. Because of this, there is an inflexibility about the form that the mark on the web of material may take.
There is no possibility of a teaching function (i.e. a function to train the sensor to detect a mark) for learning more complex types of mark. The mark could for example be part of the printed image itself.
Because of the scanning mode of operation of the sensor there is normally a dead time, the reason for which can be found in the reaction to a change of contrast (printed mark ⇄no printed mark). The sensor performs time-consuming calculations to establish that an appropriate edge of the mark has been detected. This dead time has to be compensated for in the automation system and this is a complicated process.

### Binary Camera-Based Sensors

As an alternative to binary sensors for printed marks, what are already being developed at the present time are inexpensive CCD-based systems, although to date these only emit a binary signal in the longitudinal direction of the mark.

In the course of this development, most of the same advantages as camera-based systems have are already being achieved and even today the costs are already in the same sort of range as those of sensors for printed marks.

An example that may be mentioned is a CCD camera: by looking at a large number of exposures made in quick succession, a printed mark can be detected from the pixel information and its position relative to the CCD sensor array can be measured (in the longitudinal and lateral directions). The camera scans a field that is larger than the printed mark to be scanned for in this case.

Disadvantages that exist when use is made of binary camera-based sensors are that
At the present time, these sensors allow detection to take place only in the longitudinal direction.
They have no provision for incorporating predefined types of mark to improve the recognition of features.
They do not include any compensation for dead time. To date, the mark has only been detected and a binary signal emitted by looking at images taken in quick succession. By looking at a plurality of images that are taken, a system for compensating for dead time can determine the speed of movement of the mark and, with a knowledge of the sensor's dead time caused by processing, is able to generate the binary output signal with high accuracy in such a way that no dead time results.

### Camera-Based Systems

Normal camera-based systems are in most cases what are referred to as “smart cameras” and these
are either equipped with complicated and costly (Ethernet) interfaces (e.g. the Sick IVC-2D),
or have binary outputs that only detect the presence of a product (e.g. the Cognex Checker). These binary outputs are too slow for register-control applications and, what is more, provide information only on the presence of a product.
   These systems are either very expensive or do not have the functionalities that are required for controllers of longitudinal and lateral register.

Disadvantages that exist when use is made of camera-based systems are that
The binary output signals are too slow for the above-mentioned application (they are normally generated by the camera's internal analyzing software). Because of the slow cycle time of the cameras, the reaction in question is subject to severe jitter and this has a direct effect on the accuracy with which position is determined.
The costs imposed by cameras are very high: on the one hand the current purchase prices are very high due to the complex internal signal processing and on the other hand the cameras have to be connected in in a complicated and costly fashion by Ethernet when the applications are of the kind aimed at in the present case to register controllers.

### Sensors for Streams of Printed Marks

Sensors for streams of printed marks scan a stream of marks and emit the information relating to longitudinal or lateral register, as the case may be, by means of complicated and expensive interfaces (typically of the Ethernet type). The products of the Premosys company are an example of this. FIG. 6 shows a stream of marks of this kind comprising the printed marks DW1, DW2, DW3, DW4 and DW5, with the individual marks being of different colors (shown as different hatchings in FIG. 6) and comprising for example two triangle shapes of a width of 6 mm that are offset from one another, the pairs being spaced apart at a distance of 20 mm.

Disadvantages that exist when use is made of sensors for streams of printed marks are that
Only a few types of mark can be detected because the sensor detects a printed mark by using a spot of light rather than by using image-processing techniques.
A different setting for the sensor or even a different sensor has to be selected to suit the color of the printed mark. The spot of light produced by a light source in the sensor is generally monochrome and is therefore not able to detect every color. Where required by the color of the mark to be detected, the sensor may have to be replaced or an additional sensor may have to be present.
There is no possibility of a teaching function for learning more complex types of mark. The mark could for example be part of the printed image itself.
The costs imposed by sensors for stream of marks are very high: on the one hand the current purchase prices are very high due to the complex analyzing program and on the other hand the cameras often have to be connected in in a complicated and costly fashion by Ethernet when the applications are of the kind aimed at in the present case to register controllers.
The accuracy with which the spot of light has to be positioned is relatively high. In contrast to this, a camera-based system has to scan a window that is of a larger size than can be expected simply from the size of the mark and from the maximum positional deviation that is expected.

### SUMMARY OF THE INVENTION

It is therefore an object of the present invention to provide a sensor for marks on or in material whose purchase price will be low, that works quickly in operation and that is easy to set.

It is also an object of the present invention to provide a method of detecting a mark on or in a material that can be used at low cost, that works quickly in operation and that is easy to set.
These objects are achieved by a sensor for marks on or in material that has the features of claim 1, by a method of detecting a mark on or in a material that has the features of claim 18 and by a method for the two-dimensional detection of a mark on or in a material that has the features of claim 19.

Advantageous embodiments of the invention are given in the respective sets of dependent claims.

A sensor according to the invention for detecting a mark on or in a material comprises:
a camera sensor that is designed to scan, at least by a line scan, a portion of the surface of the material for the mark, and
an analyzing logic unit that is coupled to the camera sensor to emit, when a mark on that portion of the surface of the material that is scanned is detected by the camera sensor, a signal for the detection of a mark on or in the material, which signal corresponds to a position of the mark on or in the material, and the analyzing logic circuit also being designed to use logic elements set to perform fixed logic operations (in other words to use set interlinkings or linkages of logic elements) to determine the signal for the detection of a mark on or in the material.

A method according to the invention of detecting a mark on or in a material comprises the following steps:
scanning, at least by a line scan, of a portion of the surface of the material for the mark, and
emission, when a mark on that portion of the surface of the material that is scanned is detected, of a signal for the detection of a mark on or in the material, which signal corresponds to a position of the mark on or in the material, the determination of the signal for the detection of a mark on or in the material taking place by the use of logic elements that are set to perform fixed logic operations.

A method according to the invention for the two-dimensional detection of a mark on or in a material comprises the following steps:
scanning, at least by a line scan (or line by line scan), of a portion of the surface of the material for the mark, and
emission, when a mark on that portion of the surface of the material that is scanned is detected, of two signals for the detection of a mark on or in the material, which signals correspond to a position of the mark on or in the material in an orientation parallel to the direction of movement of the web of material and in an orientation orthogonal thereto.

The present invention is based on the realization that, because a camera sensor is used to scan a portion of the surface of a material for a mark at least by a line scan, what are already being used as camera sensors are simply conventional, inexpensive mass-produced cameras of the kind that are already being used for, for example, mobile telephones or webcams. However, analysis of the camera image that is detected has, to date, been software-controlled, which means that analysis of the portion of surface that is scanned is very time-consuming. By using an analyzing logic unit in which the logic elements are set to perform fixed logic operations, in the form for example of fixed logic programmed into the semiconductor component concerned, it is possible to dispense with the slow, software-controlled analysis, and a mark on or in the material can thus still be detected quickly enough when the material is being transported at high speed.

The approach according to the invention has the advantage that the use of a camera that is a mass-produced product makes it possible for an appreciable reduction in costs to be achieved in the field of mark detection with, at the same time, fast analysis by virtue of the fixed logic operations set for the logic elements in the analyzing logic unit.

In a beneficial embodiment of the present invention, the camera sensor is designed to scan the portion of the surface of the material for a mark in two dimensions. This enables a good distinction to be made between marks of different types that differ in being of different two-dimensional layouts. What is more, a camera sensor based on conventional cameras is already able to sense a portion of surface in two dimensions, which means that the full functionalities of camera sensors of this kind can be taken advantage of.

In a further embodiment of the present invention, the analyzing logic unit may be designed to emit a first signal level at its signal output as a signal for the detection of a mark on or in the material when a mark is detected, and a second signal level different than the first signal level at its signal output when the mark is not detected. By binary signaling of this kind by the analyzing logic unit of the detection of a mark on or in the material it becomes possible for the signal for the detection of a mark on or in the material to be emitted quickly.

In another embodiment of the present invention, the analyzing logic unit may also be designed to cause a first change in the level of the signal for the detection of a mark on or in the material when a beginning of the mark on the material is detected, and a second change in the level of the signal for the detection of a mark on or in the material when an end of the mark on the material is detected. Signaling of this kind by means of a change in the edge of the signal for the detection of a mark on or in the material enables times at which the mark was detected on the material to be signaled quickly and above all accurately, which signaling would not be possible to the same sort of accuracy if it were purely the state of the signal for the detection of the mark in or on the material that was controlled.

It is also beneficial for the analyzing logic unit to be designed to sense a position of the mark on the material in a direction orthogonal to the direction of movement, i.e. a lateral position thereof, and to emit the signal for the detection of a mark on or in the material for a length of time that corresponds to the lateral position that is sensed for the mark or, if the signal for the detection of a mark on or in the material has a first and a second sub-signal, to emit signal edges constituting the first and second sub-signals between which there is an interval of time that corresponds to the width of the mark on the material. Not only is the presence of a mark on the material signaled in this way but information can also be obtained on the form of the mark from the fast binary signal(s) for the detection of a mark on or in the material. This simplifies the further processing of the signal(s) for the detection of a mark on or in the material by other units.

In a further embodiment of the present invention, the analyzing logic unit may be designed to detect edges of the material. Use may for example be made of this provision to enable both the edges of sheets and also the marks on the sheets to be detected when individual sheets are being processed. A distance between the marks on a sheet and the edge of the sheet can be determined by this means, in order for example to allow the printed image to be controlled in relation to the edge of the sheet rather than (as in the case of printed marks) only the different colors printed being controlled in relation to one another.

Also, the camera sensor and the analyzing logic unit may have electronic semiconductor components that are designed to carry out real-time signal processing in which the maximum delay in the output signal for the mark on the material from the detection of a beginning or end of the mark on the material is less than 100 microseconds. The advantage that this gives is that, because of the real-time signal processing, the detection of marks in or on the material can be performed even for web processing machines in which the web of material travels very fast. Because of the fast analysis, accurate determination of the position of the mark on or in the web of material is also possible.

In a further embodiment of the present invention the analyzing logic unit is designed to switch from an operating mode to a training mode in which a given region in an image of the portion of surface that is generated by the camera sensor is detected as a mark on the material and is stored in the analyzing logic unit as a reference standard for the detection of a mark in the operating mode. The given region may for example be extracted automatically by the sensor from the image of the portion of surface by looking at differences in contrast or color (“learning” of reference standards). The advantage that is achieved in this way is not only that marks on or in the material that have preset layouts can be detected but also that the sensor for marks on or in material can be taught new forms of mark. This increases the possibilities that there are for using a sensor of this kind for marks on or in a material.

In a special embodiment of the invention, the analyzing logic unit may be designed to store the forms of different types of mark as reference standards and to detect a mark on or in the material if a comparison of the mark that is sensed with one of the stored reference standards produces a positive result. With an embodiment of this kind, it becomes possible, while marks on or in the material are being detected, for a comparison to be made with marks stored in the memory, thus enabling different marks to be detected with the same sensor setting while the sensor for marks in or on material is operating.

Specifically, in a further embodiment of the invention, the analyzing logic unit may be designed to contain a plurality of forms of different types of mark in a predefined form as reference patterns or standards. This enables different forms of marks to be detected even without any protracted training, thus enabling the sensor for marks in or on material to be put into operation quickly to detect the most common types of mark.

It is also beneficial if, in a further embodiment of the invention, the analyzing logic unit is designed to be able to select one of the stored reference standards as a standard for comparison for the purpose of analysis. Should a plurality of different stored types of mark occur, this advantageously makes it possible for register control to be selected and triggered accurately in response to one of the various forms of mark that is able to be distinguished by the sensor for marks on or in material.

An embodiment of the invention that is particularly advantageous is one in which the analyzing logic unit is designed to be able to perform the selection of the stored reference standard by means of binary inputs. This makes it possible for a fast and electronically controllable (i.e. quickly switchable) choice to be made of that form of mark which the sensor for marks on or in material is to respond to.

The analyzing logic unit may also be designed to allow the selection of the stored reference standard to take place by means of a switch and/or key at the sensor. This allows manual action to be taken, or in other words an appropriate mark layout to be selected, by an operator, which is particularly advantageous for the commissioning (e.g. after conversion) of a web processing machine.

The camera sensor may in particular also be designed to distinguish different colors of mark, the analyzing logic unit being designed to distinguish forms of mark of the same type from one another by their different colors. This also makes it possible for different marks on the material to be distinguished while the sensor setting or position is left unchanged, and a distinguishing process of this kind can be used to allow a more detailed analysis to be made of the mark on the material than is possible simply by analyzing the form of the mark.

In a particular embodiment of the present invention, the camera unit may also be designed to sense the mark more than once in the portion of the surface of the material that is scanned, in which case the analyzing logic unit may be designed to determine a speed of transport of the material from two of the more than one sensings of the mark in the portion of surface. This multiple sensing of a mark in the portion of surface makes a check possible on the speed of the material, and of the marks situated on it, that is independent of external signals. By using the speed that is determined, it is possible in this way for the sensing of a mark on the material, or for the distinguishing thereof from similar layouts on the material, to be improved in a subsequent analysis.

Also, in another embodiment of the present invention, the time taken to process a signal in the camera sensor and the analyzing logic unit being known, the analyzing logic unit is designed to make the signal for the detection of a mark on or in the material available in such a way that the dead time caused by the processing of the signal in the camera sensor and analyzing logic unit is compensated for. This prevents a long delay being caused to the signal for the detection of a mark on or in the material by the processing algorithms in sensors for marks on or in material. It is possible by this means for a signal for the detection of a mark on or in the material that is independent of the speed of the material below the camera sensor to be obtained, which signal ensures that the control of register for controlling the web, and the actuation of the units for processing the material, take place in good time.

In another embodiment of the present invention, the analyzing logic unit may be designed to perform the analysis of the portion of the surface of the material that is scanned by the camera sensor in response to external triggering. This makes it possible for the analyzing unit not to remain in operation continuously but to be switched on only for an operating run of the web processing machine. As well as saving energy, this also causes an optimization of a flow of signals when for example the travel of a mark on the material is to be tracked by a plurality of sensors for detecting marks on or in material that are arranged in distributed positions in a web processing machine, a control unit then interrogating only the appropriate sensors for detecting marks on or in material at which the mark on or in the material should be situated at the time for signals. It is possible in this way for any disruption of the tracking of a mark by any subsequent marks of the same kind that may exist to be largely avoided.

Furthermore, there may also be provided, in a particularly advantageous embodiment of the invention, a web processing machine for processing a web of material that has the following features:
a sensor for marks on or in material for detecting a mark a mark on or in the web of material, of the kind that has been described above, and
a processing unit that is designed to perform a step of processing on the web of material in response to the mark detected by the sensor for detecting marks on or in material.

The advantages of the present invention are particularly effective in an embodiment of the present invention of this kind because it is inexpensive, fast and very accurate determination of position of the kind that is ensured precisely by the sensor for detecting marks on or in material described above that is required in co-operation of this kind between the sensor for detecting marks on or in material and the processing unit.

### BRIEF DESCRIPTION OF THE DRAWINGS

Other advantages, features and details of the invention can be seen from the following description of an embodiment that is shown in the drawings. In the drawings:

FIG. 1 is a schematic view of a first embodiment of sensor according to the invention for detecting marks on or in material.

FIG. 2 is a schematic view of waveforms for the signal for the detection of a mark on or in material.

FIG. 3 is a flow chart for an embodiment of the invention in the form of a method.

FIG. 4 is a view of a web processing machine having a register control system.

FIG. 5 is a view of an arrangement for scanning a mark on or in material.

FIG. 6 is a view of a stream of printed markers that can be used to mark a material.

### DETAILED DESCRIPTION OF THE INVENTION

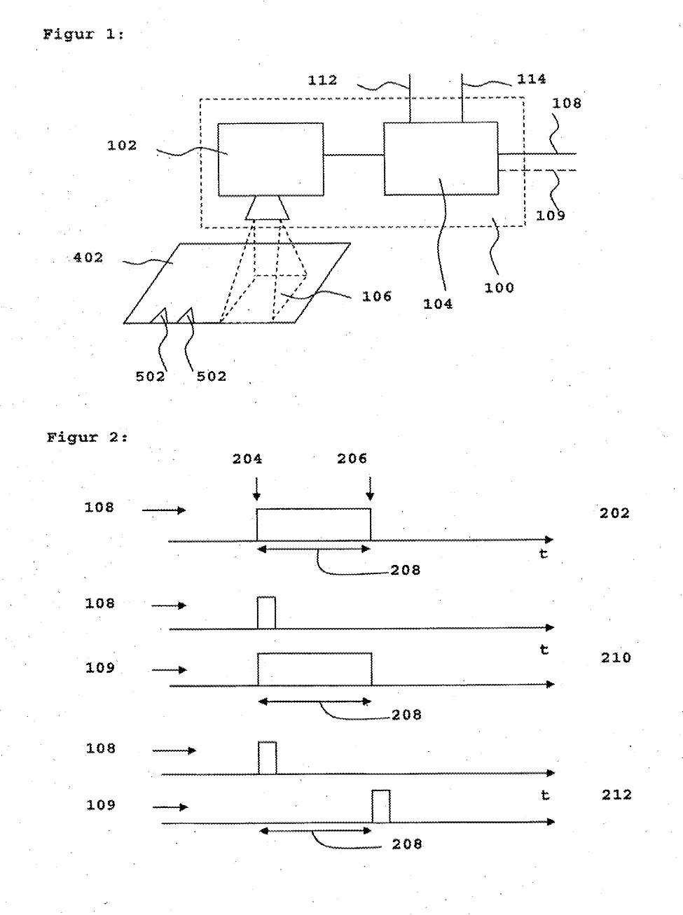

FIG. 1 is a schematic view of a first embodiment of sensor 100 according to the present invention for detecting marks on or in material, for detecting a mark on or in a material 402. The sensor 100 for marks in or on material comprises a camera sensor 102 and an analyzing logic unit 104 that is coupled to the camera sensor 102. The camera sensor 102 is able to scan a portion 106 of the surface of the material 402 (which may for example be a web of material in a web processing machine) for marks 502 and to pass on a corresponding signal to the analyzing logic unit 104. In the analyzing logic unit 104, the signal supplied by the camera sensor 102 can be analyzed (by, for example, being compared with a preset reference standard) and, if a mark is detected in the portion 106 of surface that is scanned, a signal 108 for the detection of a mark on or in the material can be emitted. The signal 108 for the detection of a mark on or in the material may be emitted either alone or in combination with an auxiliary signal 109, as will be explained in detail below. A downstream processing unit of a web processing machine 400 may for example be actuated by means of this signal 108 for the detection of a mark on or in the material. If for example the web processing machine 400 is a printing press that prints in more than one color where the different colors are applied to the material 402 in downstream processing units, very accurate positioning of the printed images in the different colors can be achieved by means of the analysis of the marks 502 and the emission of the signal 108 for the detection of a mark on or in the material.

In the embodiment of the present invention that is shown in FIG. 1, what may be used as a camera sensor 102 is for example a conventional inexpensive CCD camera or some other photoelectric sensor of a kind that is also used in mass-produced products (e.g. mobile telephones, webeams, etc.). However, if the signal 108 for the detection of a mark on or in the material is to be made available in good time for the actuation of further units for processing the web of material 402, conventional software-based analysis of marks 502 that are detected in the portion 106 of surface is not good enough. Such software-based analysis of layouts in the portion 106 of surface is, in particular, too slow for web processing machines. For this reason, provision is made in accordance with the invention for the signal 108 for the detection of a mark on or in the material to be determined in the analyzing logic circuit 104 on the basis of a logic elements set to perform fixed logic operations. The analyzing logic unit 104 may for example be designed to take the form of an application-specific integrated circuit (ASIC) or a field-programmable gate array (FPGA). It is not essential for the fixed logic operations of the logic elements of the analyzing logic unit 104 to be set in their fixed form by the manufacturer of the sensor 100 for detecting marks on or in material and instead the fixed logic operations of the logic elements can be loaded afresh from a memory before each start of a process of detecting marks on or in a material. The sensor 100 for detecting marks on or in material may for example be set for different forms of mark in this way. Because of the fixed logic operations that are set for the logic elements, the analyzing logic unit 104 operates considerably faster than software-based analysis of the marks in the portion 106 of surface. In combination with an inexpensive camera sensor 102, it is therefore possible for a sensor 100 for detecting marks on or in material to be provided that, as compared with the prior art, is very low in cost and at the same time operates fast.

The camera sensor 102 should be so designed that it at least makes a line scan of the web of material 402. The camera sensor 102 may for example scan the web of material 402 transversely to the direction of transport 110. When the form of the marks 502 is known, the position of the web of material 402 can be sensed in an easy and very accurate way in the portion 106 of surface that is sensed by the camera sensor 102. The position of a mark 502 on the web of material 402 may for example be determined from the sensed extent of the said mark transversely to the direction of transport 110. Scanning of the portion 106 of surface by a line scan in the direction of transport 110 can also make it possible for the position of a mark 502 on the web of material 402 to be accurately determined. What may be sensed in this case is for example the extent of the marks 502 in the direction of transport 110.

It can thus be seen that the first embodiment of the invention aims to achieve an advantageous combination of the following features for a sensor:
A camera-based analysis is to be made of marks (by means for example of a CCD camera or a line-scan camera)
An analysis of the sensor signals is to be an integral part of a camera (in a similar way to a smart camera).
Binary outputs are to be provided that allow position to be determined in the direction of travel of the web and transversely to the direction of travel of the web, and
Fast signal outputs are to be provided that are suitable for applications in machines that run at high speed.

Today's camera systems may, in principle, already have some of the functions mentioned (though they cause higher costs and have only a lower speed of processing), but a considerably improvement over the prior art can be achieved by combining a camera sensor with
analyzing logic that is programmed in a fixed form, and/or
variant types of analysis whose functions are compatible with sensors for printed marks.
   Today's smart cameras on the other hand can be programmed for their applications, which makes them expensive, and are also to slow to actuate components of a machine that processes a web of material at high speed. To make it possible for the portion of surface to be analyzed sufficiently fast, what is proposed as a solution for the analyzing unit is one that is not programmable and whose functionality with respect to certain forms of mark is advantageously similar to that of an (inexpensive) sensor for printed marks.

With regard to the outputs forming the signal 108 for the detection of a mark on or in the material (and the auxiliary signal 109), it should be noted that these may be binary outputs that, for register control systems, take the form of real-time outputs that react appropriately fast. Fast in the context of the process means, in this case, that, in the case of machines running at high speed in which speed of the web is typically up to 10-20 m/s, the sensor for marks on or in material is able to process the measured values so fast that very high accuracies of measurement of less than 100 μm can be achieved. 10 m/s for example corresponds to 10 μm/μs, i.e. the sensor for marks on or in material should have a maximum temporal jitter in its binary output of 10 μs if, in conjunction with ideally fast scanning of position, a maximum positional jitter of 100 μm is to be achieved.

FIG. 2 shows different views of signal waveforms for the signal 108 for the detection of a mark on or in the material and for the auxiliary signal 109, plotted against time t. In the plot 202 at the top of FIG. 2 is shown a signal waveform when only a single signal 108 for the detection of a mark on or in the material is used. At a first point in time 204, a beginning of a mark 502 on the web of material (a mark edge for longitudinal register) is detected. At a second point in time 206, the end of the mark 502 on the web of material 402 is detected. A conclusion as to the width of the mark 502 and as to the position of the mark within the portion 106 of surface can then be drawn from the interval of time 208 between the edges of the signal at the first and second points in time 204 and 206 respectively. Longitudinal and lateral register can also be controlled by means of the edge and pulse length.

In the center plot 210 in FIG. 2 are shown the signal waveforms when the signal 108 for the detection of a mark on or in the material and the auxiliary signal 109 are used. In this case merely a short pulse (a rising edge for longitudinal register) may be emitted at the first point in time 204 to form the signal 108 for the detection of a mark on or in the material, whereas a state-controlled signal corresponding to the width of the mark 502 (a pulse length for lateral register) can be emitted to form of the auxiliary signal 109. The first output (i.e. the signal 108 for the detection of a mark on or in the material) may for example operate in such a way that it represents the position of the mark in the longitudinal direction (longitudinal register). The second output (i.e. the auxiliary signal 109) operates in such a way that its pulse length is a measure of lateral register. When this is the case the signal 108 for the detection of a mark on or in the material may for example be used for triggering in a downstream processing unit of a web processing machine, whereas the auxiliary signal 109 is used for the checking, i.e. detailed monitoring, of marks 502 on the web of material 402.

Shown in the bottom plot 212 in FIG. 2 are the signal waveforms for the signal 108 for the detection of a mark on or in the material and for the auxiliary signal 109 in a different variant. In contrast to the variant illustrated by the center plot in FIG. 2, provision is now made, in the variant shown in the bottom plot in FIG. 2, for the auxiliary signal 109 too to be, as can be seen, a short pulse (a pulse for the descending edge). The width of a mark 502 on the web of material 402 can be determined from the interval of time 208 between the pulses forming the signal 108 for the detection of a mark on or in the material and the auxiliary signal 109. Unlike the variant shown in the center plot 210, in the present case lateral register is represented by the interval between the edge of the signal 108 for the detection of a mark on or in the material (e.g. the beginning of the mark) and the edge of the auxiliary signal 109 (e.g. the end of the mark). Compared with a state-controlled signal such as is shown in the top plot 202 and the center plot 210, a pulse-controlled signal gives greater temporal accuracy for some applications, whereby it is also possible for a position of the mark 502 on the web of material 402 to be determined with greater accuracy.

It goes without saying that the levels of the two signals 108 and 109 and the edges thereof that are to be analyzed may be variable, and, for example, the levels shown in FIG. 2 may be inverted.

In a further embodiment, the sensor for marks on or in material may have a teaching input 112 (i.e. a signal input by means of which a learning function can be activated in the analyzing logic unit 104), as shown in FIG. 1. When this is the case, there is a further (e.g. binary) input 112 or button present on the sensor 100 for marks on or in material by means of which a teaching process can be started. The purpose of this teaching process is to teach the form of a mark. In the case of a sensor of the present kind for marks in or on material, teaching is possible in a relatively easy way by bringing the mark to be detected into place below the sensor (or holding it thereunder manually) and then giving the sensor a teach command (e.g. also in the form of a binary signal). Acting as a sensor, the camera then detects typical structures in the images recorded by it and from these it is able to obtain features to allow a strategy for the detection of the mark to be laid down on the basis of the features. The mark (or rather the form of mark) that is situated in the field of vision of the camera sensor 102 when the teaching process is initiated is therefore learned as a form of mark. In the case of fairly simple forms of mark, a special teaching process may not be needed at all or the obtaining of the features from the images that are recorded is simplified. Alternatively, the teaching process may also take place in such a way that, following activation of the teaching process, the next mark that is detected as an optical layout in the field of vision of the sensor is learned as a desired form of mark. This latter variant makes learning possible “on the fly” when the web of material is in motion without any need for an operation, which generally has to be carried out manually, to bring the mark below the sensor and into the field formed by the portion 106 of surface. This simplifies the application of the teaching process even further.

The camera sensor 102 may also take the form of a color sensor. The possibility of analyzing colors means that forms of mark of the same type can be differentiated from one another by their different colors. For example, on a machine that employs a plurality of printed marks that, though of the same type, are of different colors, the sensor is able to filter out one of the printed marks by this means.

In another beneficial embodiment of the present invention, the sensor for marks in or on material may perform compensation for dead time by an automated process. This can be done in the following way:

If the mark to be detected is detected more than once in the field of vision of the camera, the speed of movement of the mark can be calculated by the camera from the measurements made. On the basis of this speed of movement and a knowledge of the processing time in the camera, the camera can control the output signals in such a way that the processing dead time within the camera is compensated for. What is obtained as a result is a binary signal not dependent on speed that always becomes active at the same point in time at which the mark is situated under the sensor. This is something that, by comparison, a sensor for printed marks is not able to do, because it does not sense speed of movement in the prior art.

As a further option, the possibility exists of simplifying the teaching process by means of types of mark that are learned as standard. If the sensor has types of mark that have been learned beforehand and stored in a memory or if the sensor is able to store learned types of mark internally in the memory, these types of mark can be selected, as a function of the production that is being done, without a (fresh) teaching process. The selection can be made locally at the sensor in this case, being made for example by means of binary inputs 112, by means of a rotary switch, or in some other way. Standard types of mark may for example be block/triangle/double triangle marks, dot marks, square marks, etc.

Alternatively, the sensor may also be so designed that it automatically compares the plurality of types of mark stored in the memory with the marks that are detected on the web of material, which means that it is then not possible for a single type of mark that is to be filtered out to be explicitly selected and the binary signals for selecting a type of mark are then not required.

In a further embodiment of the invention, provision may also be made for external triggering of the scanning of the portion 106 of surface by means of a triggering input 114 on the analyzing logic unit 104, as shown in FIG. 1. Basically, the way in which a sensor 100 for marks in or on material works will be that the sensor 100 performs image analyses in quick succession and compares them with the marks that have been learned. As an option, the sensor may also include facilities for the external triggering of an exposure or a short sequence of exposures rather than performing fast internally controlled scanning that takes place continuously.

In a further embodiment, provision could be made for the comparison of types of mark with the stored reference standards also to take place with allowance made for the magnifying effect. What this means is that the size in which the mark exists at the sensor may for example be 2 mm×5 mm but, even though the size of mark that the sensor scans is 1 mm by 2.5 mm, the sensor is still able to detect the mark.

The number of reference marks that are stored in fixed form or have to be learned can be reduced in this way, and any vertical “flapping” of the web could also be tolerated by this means. If the web flaps vertically, the distance between the web and the sensor varies and hence so too does the size of mark that is recorded. If allowance is made for this, the position of the mark may possibly also be determined more accurately.

In a further embodiment, the invention may also be used in a machine that operates in cyclically and product-wise as happens for example in the packaging industry. In this case it is usually the position of products that is sensed with great accuracy by means of camera systems. Pick and place operations for example are also controlled with this information by using the position that is determined to specify a target for a kinematic pick and place mechanism, i.e. the products arrive at almost arbitrary points in time and their positions are determined by means of the camera.

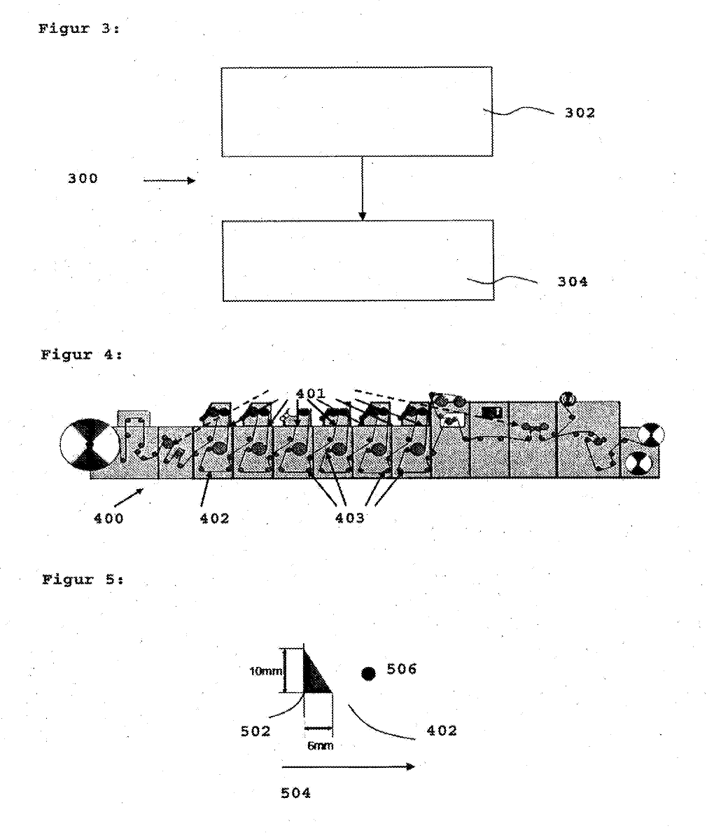

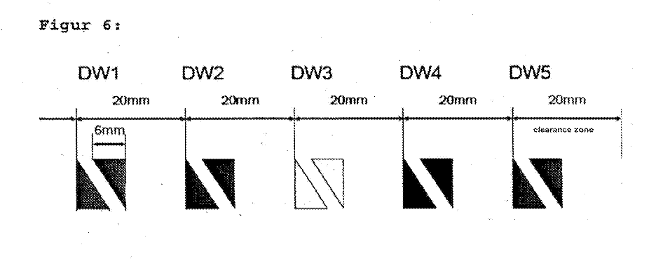

The present invention may also take the form of a method 300 of detecting a mark on or in a material such as is shown in FIG. 3. The advantages mentioned are also achieved in this embodiment of the invention. In a first step 300 there is a scan, at least by a line scan, of a portion of the surface of the material for the mark. Following this, there is the emission 304 of a signal for the detection of a mark on or in the material when a mark is detected on the portion of the surface of the material that is being scanned, the signal for the detection of a mark on or in the material corresponding to a position of the mark on or in the material, and the determination of the signal for the detection of a mark on or in the material taking place by the use of logic elements set to perform fixed logic operations.

What is claimed is:

1. A sensor (100) for sensing a mark (502) on or in a material, the sensor comprising:
a camera sensor (102) that scans, at least by a line scan, a portion (106) of the surface of the material (402) for the mark (502); and
an analyzing logic unit (104) connected to the camera sensor (102) to emit a signal (108) when the mark (502) is detected by the camera sensor (102) on the scanned portion (106) of the surface of the material (402), wherein the signal corresponds to a position of the mark (502), and wherein the analyzing logic unit (104) includes logic elements set to perform fixed logic operations to determine the signal (108) emitted by the analyzing logic unit (104).

2. A sensor (100) as claimed in claim 1, wherein the camera sensor (102) is designed to scan the portion (106) of the surface of the material (402) for the mark (502) in two dimensions.

3. A sensor (100) as claimed in claim 1, wherein the analyzing logic unit (104) is designed to emit a first signal level at its signal output as a signal (108) when the mark (502) is detected, and a second signal level different than the first signal level at its signal output when the mark (502) is not detected.

4. A sensor (100) as claimed in claim 1, wherein the analyzing logic unit (104) is designed to cause a first change in the level of the signal (108) when a beginning of the mark (502) on the material (402) is detected, and a second change in the level of the signal (108) when an end of the mark (502) on the material (402) is detected.

5. A sensor (100) as claimed in claim 3, wherein the analyzing logic unit (104) is designed to sense a width of the mark (502) on the material (402) and/or a position thereof that is orthogonal to the direction of movement of the web of material, and to emit the signal (108) for a length of time (208) that corresponds to the width that is sensed for the mark (502) and/or the position that is sensed therefor that is orthogonal to the direction of movement of the web of material or, if the signal (108) has a first and a second sub-signal, to emit edges constituting the first and second (109) sub-signals between which there is an interval of time corresponding to the width of the mark on the material and/or to the position of the mark (502) on the material (402) that is orthogonal to the direction of movement of the web of material.

6. A sensor (100) as claimed in claim 4, wherein the analyzing logic unit (104) is designed to sense a width of the mark (502) on the material (402) and/or a position thereof that is orthogonal to the direction of movement of the web of material, and to emit the signal (108) for a length of time (208) that corresponds to the width that is sensed for the mark (502) and/or the position that is sensed therefor that is orthogonal to the direction of movement of the web of material or, if the signal (108) has a first and a second sub-signal, to emit edges constituting the first and second (109) sub-signals between which there is an interval of time corresponding to the width of the mark on the material and/or to the position of the mark (502) on the material (402) that is orthogonal to the direction of movement of the web of material.

7. A sensor (100) as claimed in claim 1, wherein the camera sensor (102) and the analyzing logic unit (104) have electronic semiconductor components that carry out real-time signal processing in which the maximum delay in the output signal (108) for the mark on the material from the detection of a beginning or end of the mark (502) on the material (402) is less than 100 microseconds.

8. A sensor (100) as claimed in claim 1, wherein the analyzing logic unit (104) is designed to switch from an operating mode to a training mode in which an image of the portion (106) of the surface of the material (402) that is supplied by the camera sensor (102) is detected as a mark (502) on the material (402) and is stored in the analyzing logic unit (104) as a reference standard for the detection of a mark (502) in the operating mode.

9. A sensor (100) as claimed in claim 8, wherein the analyzing logic unit (104) is designed to store the forms of different types of marks as reference patterns or standards and to detect the mark (502) on or in the material if a comparison of the mark (502) that is sensed with one of the stored reference standards produces a positive result.

10. A sensor (100) as claimed in claim 1, wherein the analyzing logic unit (104) is designed to store a plurality of forms of different types of marks in a predefined form as reference standards.

11. A sensor (100) as claimed in claim 10, wherein the analyzing logic unit (104) is designed to be operable to select one of the stored reference standards as a standard for comparison for the purpose of analysis.

12. A sensor (100) as claimed in claim 11, wherein the analyzing logic unit (104) is designed to be operable to perform the selection of the stored reference standard by means of binary inputs.

13. A sensor (100) as claimed in claim 11, wherein the analyzing logic unit (104) is designed to allow the selection of the stored reference standard to take place by means of a switch and/or key at the sensor.

14. A sensor (100) as claimed in claim 1, wherein the camera sensor (102) is designed to distinguish different colors of the mark (502), and the analyzing logic unit (104) is designed to distinguish forms of the mark (502) of the same type from one another by their different colors.

15. A sensor (100) as claimed in claim 1, wherein the camera sensor (102) is designed to sense the mark (502) more than once in the portion (106) of the surface of the material (402) that is scanned, and the analyzing logic unit is designed to determine a speed of the material (402) from two of the more than one sensings of the marks (502) in the portion (106) of surface.

16. A sensor (100) as claimed in claim 15, wherein the time taken to process a signal in the camera sensor (102) and the analyzing logic unit (104) is known, and the analyzing logic unit (104) is designed to make the signal (108) available in such a way that the dead time caused by the processing of the signal in the camera sensor (102) and analyzing logic unit (104) is compensated for.

17. A sensor (100) as claimed in claim 1, wherein the analyzing logic unit (104) is designed to perform the analysis of the portion of the surface of the material (402) that is scanned by the camera sensor (102) in response to external triggering.

18. A web processing machine (400) for processing a web (402) of material, the web processing machine comprising:
a sensor (100) for detecting a mark on or in the web of material (402), the sensor comprising:
a camera sensor (102) that scans, at least by a line scan, a portion (106) of the surface of the material (402) for the mark (502); and
an analyzing logic unit (104) connected to the camera sensor (102) to emit a signal (108) when the mark (502) is detected by the camera sensor (102) on the scanned portion (106) of the surface of the material (402), wherein the signal corresponds to a position of the mark (502), and wherein the analyzing logic unit (104) includes logic elements set to perform fixed logic operations to determine the signal (108) emitted by the analyzing logic unit (104); and
a processing unit designed to perform a step of processing on the web of material (402) in response to detection of the mark (502) by the sensor (1 00).

19. A method of detecting a mark (502) on or in a material (402), wherein the method comprises the steps of:
scanning, at least by a line scan, a portion (106) of the surface of the material (402) for the mark (502); and
emitting, when the mark (502) on that portion (106) of the surface of the material (402) that is scanned is detected, a signal (108) corresponding to a position of the mark (502), wherein the signal (108) is determined through the use of logic elements set to perform fixed logic operations.

20. A method for the two-dimensional detection of a mark (502) on or in a material (402), wherein the method comprises the steps of:
scanning, at least by a line scan, of a portion (106) of the surface of the material (402) for the mark (502); and
emitting, when the mark (502) on that portion (106) of the surface of the material (402) that is scanned is detected, two signals (108, 109) corresponding to a position of the mark (502) in an orientation parallel to the direction of movement of the web of material and in an orientation orthogonal thereto.
